(19) United States
(12) Patent Application Publication
(10) Pub. No.: US 2023/0242762 A1
(43) Pub. Date: Aug. 3, 2023

(54) METHOD OF SUPPRESSING BURR OF POLYARYLENE SULFIDE RESIN COMPOSITION

(71) Applicant: POLYPLASTICS CO., LTD., Tokyo (JP)

(72) Inventors: Hidekazu IDEI, Shizuoka (JP); Katsuhei OHNISHI, Shizuoka (JP)

(73) Assignee: POLYPLASTICS CO., LTD., Tokyo (JP)

(21) Appl. No.: 18/014,774

(22) PCT Filed: Jun. 22, 2021
(86) PCT No.: PCT/JP2021/023519

§ 371 Date: Jan. 6, 2023

(30) Foreign Application Priority Data
Jul. 10, 2020 (JP) 2020-119069

(51) Int. Cl. C08L 81/02; C08K 3/04; C08K 7/14; B29C 45/00

(52) U.S. Cl. CPC C08L 81/02; B29C 45/0001; B29C 45/0005; C08K 3/041; C08K 7/14; B29K 2081/04

(57) ABSTRACT

Provided is a method of suppressing burrs that occur during injection-molding of a polyarylene sulfide resin composition, including: adding at least 0.01 to 5 parts by mass of a carbon nanostructure to 100 parts by mass of a polyarylene sulfide resin and melt-kneading at least the carbon nanostructure and the polyarylene sulfide resin.

### TECHNICAL FIELD

The present invention relates to a method of suppressing burrs that occur during injection-molding of a polyarylene sulfide resin composition.

### BACKGROUND ART

A polyarylene sulfide resin (hereinafter also referred to as “PAS resin”) represented by polyphenylene sulfide resin (hereinafter also referred to as “PPS resin”) has high heat resistance, mechanical properties, chemical resistance, dimensional stability, and flame retardancy. Therefore, the PAS resin is widely used as an electrical and electronic equipment part material, an automotive equipment part material, a chemical equipment part material, and the like. However, since the PAS resin has a low crystallization rate, the PAS resin has problems in that the cycle time during molding is long and burrs often occur during molding.

The addition of various alkoxysilane compounds is known as a method of reducing the occurrence of burrs (see Patent Literatures 1 and 2). The various alkoxysilane compounds are highly reactive with the PAS resin and enhance mechanical properties and have an effect of suppressing the occurrence of burrs, and the like. However, the effect of suppressing the occurrence of burrs is limited and the effect is not enough to fully satisfy the market demand, and the alkoxysilane compounds do not have the effect of also increasing the crystallization rate.

Therefore, various proposals have been made to suppress the occurrence of burrs without using various alkoxysilane compounds. Among the proposals, a technology has been proposed which is for suppressing the occurrence of burrs by adding a predetermined amount of a carbon material such as carbon black or carbon nanotubes (see Patent Literatures 3 to 5).

In Patent Literatures 3 and 4, a predetermined amount of carbon black was added, and in Patent Literature 5, a predetermined amount of carbon nanotubes was added, both of which were successful in suppressing the occurrence of burrs to a certain level.

### CITATION LIST

### Patent Literature

[Patent Literature 1] Japanese Examined Patent Application Publication No. Hei 6-21169
[Patent Literature 2] Japanese Unexamined Patent Application Publication No. Hei 1-146955
[Patent Literature 3] Japanese Unexamined Patent Application Publication No. 2000-230120
[Patent Literature 4] Japanese Patent No. 3958415
[Patent Literature 5] Japanese Unexamined Patent Application Publication No. 2006-143827

### SUMMARY OF THE INVENTION

### Problem to Be Solved by the Invention

As described above, the addition of a predetermined amount of carbon black or carbon nanotubes can suppress the occurrence of burrs. However, such suppression of the occurrence of burrs by means of the addition of carbon black or carbon nanotubes is not sufficient and there is room for improvement.

The present invention has been devised in view of the above past problems, and an object of the present invention is to provide a method of suppressing burrs of a polyarylene sulfide resin composition, which can sufficiently suppress burrs that occur during injection-molding of a polyarylene sulfide resin composition.

### Means for Solving the Problem

One aspect of the present invention to solve the above problems is as follows.

A method of suppressing burrs that occur during injection-molding of a polyarylene sulfide resin composition, including: adding at least 0.01 to 5 parts by mass of a carbon nanostructure to 100 parts by mass of a polyarylene sulfide resin and melt-kneading at least the carbon nanostructure and the polyarylene sulfide resin.

(2) The method of suppressing burrs of the polyarylene sulfide resin composition according to (1) above, further including: adding 5 to 250 parts by mass of an inorganic filler to 100 parts by mass of the polyarylene sulfide resin and melt-kneading at least the inorganic filler and the polyarylene sulfide resin.

(3) The method of suppressing burrs of the polyarylene sulfide resin composition according to (2) above, in which the inorganic filler is one or more selected from the group consisting of glass fibers, glass beads, glass flakes, calcium carbonate, and talc.

### Effect of the Invention

According to the present invention, it is possible to provide a method of suppressing burrs of a polyarylene sulfide resin composition, which can sufficiently suppress burrs that occur during injection-molding of a polyarylene sulfide resin composition.

### MODES FOR CARRYING OUT THE INVENTION

### Method of Suppressing Burrs of Polyarylene Sulfide Resin Composition

A method of suppressing burrs of a polyarylene sulfide resin composition (hereinafter, also simply referred to as a “burr suppression method”) of the present embodiment is a method of suppressing burrs that occur during injection-molding of the polyarylene sulfide resin composition. At least 0.01 to 5 parts by mass of a carbon nanostructure (hereinafter also referred to as “CNS”) is added relative to 100 parts by mass of the polyarylene sulfide resin and at least the carbon nanostructure and the polyarylene sulfide resin are melt-kneaded.

In the method of suppressing burrs of the PAS resin composition of the present embodiment, the occurrence of burrs is suppressed by adding a predetermined amount of the CNS to the PAS resin. The mechanism of suppressing burrs by the addition of the CNS is presumed to be due to the increase in melt viscosity in a low shear rate region and the enhancement in the crystallization rate (the enhancement in solidification rate due to a nucleating agent effect). In addition, by increasing the melt viscosity in the low shear rate region, the mold release resistance can be reduced. By enhancing the crystallization rate, the molding cycle can be shortened. In the present embodiment, “nucleating agent” is synonymous with “crystal nucleating agent”, “nucleation agent”, and the like.

Each component of a thermoplastic resin composition of the present embodiment will be described below.

### Polyarylene Sulfide Resin

The PAS resin has excellent mechanical properties, electrical properties, heat resistance, and other physical and chemical properties, as well as good processability.

The PAS resin is a high polymer compound composed mainly of -(Ar-S)- (where Ar represents an arylene group) as a repeating unit. In the present embodiment, it is possible to use a PAS resin having a generally known molecular structure.

Examples of the arylene group include a p-phenylene group, a m-phenylene group, an o-phenylene group, a substituted phenylene group, a p,p′-diphenylene sulfone group, a p,p′-biphenylene group, a p,p′-diphenylene ether group, a p,p′-diphenylene carbonyl group, a naphthalene group, and the like. The PAS resin may be a homopolymer consisting only of the above repeating unit. Alternatively, there are cases where a copolymer containing the following heterologous repeating unit is preferable in terms of processability and the like.

A preferably used homopolymer is a polyphenylene sulfide resin having, as a repeating unit, a p-phenylene sulfide group in which a p-phenylene group is used as an arylene group. Further, as the copolymer, the combination of two or more different kinds among arylene sulfide groups composed of the arylene group can be used. Thereamong, the combination containing the p-phenylene sulfide group and a m-phenylene sulfide group is particularly preferably used.

Among them, one containing 70 mol% or more and preferably 80 mol% or more of the p-phenylene sulfide group is suitable from the viewpoint of physical properties such as heat resistance, moldability, and mechanical properties. Among these PAS resins, a high molecular weight polymer with a substantially linear structure obtained by means of condensation polymerization from a monomer consisting mainly of a bifunctional halogen aromatic compound can be particularly preferably used. The PAS resin used in the present embodiment may be a mixture of two or more PAS resins with different molecular weights.

In addition to the PAS resin having the linear structure, examples also include the following: a polymer in which, during’ condensation polymerization, a small amount of a monomer such as a polyhaloaromatic compound having three or more halogen substituents is used to form a branching or crosslinked structure partially; and a polymer in which a low-molecular weight polymer having a linear structure is heated at a high temperature in the presence of oxygen or the like and melt viscosity is increased by means of oxidative cross-linking or thermal cross-linking to enhance the molding processability.

The melt viscosity of the PAS resin as a base resin used in the present embodiment (310° C., a shear rate of 1200 sec⁻¹) is 5 to 500 Pa-s from the viewpoint of the balance between mechanical properties and fluidity, including the case of the above mixed system. The melt viscosity of the PAS resin is preferably 7 to 300 Pa·s, more preferably 10 to 250 Pa·s, and particularly preferably 13 to 200 Pa·s.

In the burr suppression method of the present embodiment, the composition may contain other resin components as the resin component in addition to the PAS resin to the extent that the effect is not impaired. Other resin components are not particularly limited and include a polyethylene resin, a polypropylene resin, a polyamide resin, a polyacetal resin, a modified polyphenylene ether resin, a polyethylene terephthalate resin, a polybutylene terephthalate resin, a polyethylene naphthalate resin, a polyimide resin, a polyamideimide resin, a polyetherimide resin, a polysulfone resin, a polyether sulfone resin, a polyether ketone resin, a polyether ether ketone resin, a liquid crystal resin, a fluorine resin, a cyclic olefin resin (a cyclic olefin polymer, a cyclic olefin copolymer, or the like), a thermoplastic elastomer, a silicone-based polymer, and various biodegradable resins, and the like. In addition, two or more resin components may be used together. Among them, a polyamide resin, a modified polyphenylene ether resin, a liquid crystal resin, and the like are preferably used from the viewpoint of mechanical properties, electrical properties, physical and chemical properties, processability, and the like.

### Carbon Nanostructure (CNS)

In the burr suppression method of the present embodiment, as described above, the occurrence of burrs is suppressed by adding the predetermined amount of the CNS to the PAS resin. The CNS used in the present embodiment is a structure containing a plurality of carbon nanotubes in a bonded state. A carbon nanotube is bonded to other carbon nanotubes by branch binding or a crosslinked structure. Details of such a CNS are disclosed in U.S. Pat. Application Publication No. 2013-0071565, U.S. Pat. No. 9,113,031, U.S. Pat. No. 9,447,259, and U.S. Pat. No. 9,111,658.

In the present embodiment, other nucleating agents may be used in combination as long as the effect is not inhibited. Examples of other nucleating agents include boron nitride, talc, kaolin, carbon black, carbon nanotubes, calcium carbonate, mica, titanium oxide, alumina, calcium silicate, ammonium chloride, and the like.

The CNS used in the present embodiment may be a commercial product. ATHLOS 200, ATHLOS 100, and the like manufactured by Cabot Corporation can be used, for example. Among the above, in ATHLOS 200, an average fiber diameter of carbon nanotubes as the smallest unit constituting the CNS is around 10 nm. The average fiber diameter of carbon nanotubes as the smallest unit constituting the CNS can be 0.1 to 50 nm, and preferably 0.1 to 30 nm, for example.

In the burr suppression method of the present embodiment, the method of adding the CNS to the PAS resin is not particularly limited and can be done by performing a conventionally known method. Examples of the timing for adding the CNS include when polymerizing the PAS resin, when melt-kneading the raw material during the preparation of the PAS resin composition, and the like.

The timing for adding the CNS when melt-kneading the raw material during the preparation of the PAS resin composition may be after once the PAS resin and CNS are heated and melt-kneaded and a pelletized masterbatch is obtained. In such cases, a masterbatch may be fabricated by using a resin other than the PAS resin, as long as the burr suppression effect produced by the CNS is not impaired.

In addition, the CNS may be added after forming a mixture obtained by once simply stirring the PAS resin and CNS. In such a case, a method of dry-blending the PAS resin and CNS, or the like can be taken as an example. A blending method using a tumbler, Henschel mixer, or the like may be used.

In the method of blending and melt-kneading the PAS resin and CNS, both of the PAS resin and CNS may be supplied to an extruder respectively, the PAS resin, CNS, other blending agents, and the like may be dry-blended before being supplied to the extruder, or a part of the raw material may be supplied by means of a side feed method, for example.

In the burr suppression method of the present embodiment, 0.01 to 5 parts by mass of the CNS is added relative to 100 parts by mass of a thermoplastic resin. When the addition amount of the CNS is less than 0.01 parts by mass, the suppression of the occurrence of burrs is insufficient. When the addition amount of the CNS is more than 5 parts by mass, the viscosity tends to increase remarkably, and the moldability tends to deteriorate. The addition amount of the CNS is preferably 0.05 to 3 parts by mass, more preferably 0.15 to 2.5 parts by mass, and particularly preferably 0.5 to 1.7 parts by mass.

### Inorganic Filler

In the present embodiment, it is preferable to include an inorganic filler in the PAS resin composition from the viewpoint of enhancing mechanical properties. Examples of the inorganic filler include a fibrous inorganic filler, a plate-like inorganic filler, and a granular inorganic filler. Among the above, one of them may be used alone or two or more of them may be used in combination.

Examples of the fibrous inorganic filler include mineral fibers such as glass fibers, carbon fibers, zinc oxide fibers, titanium oxide fibers, wollastonite, silica fibers, silica-alumina fibers, zirconia fibers, boron nitride fibers, silicon nitride fibers, boron fibers, and potassium titanate fibers; and metallic fibrous materials such as stainless steel fibers, aluminum fibers, titanium fibers, copper fibers, and brass fibers. One of the above may be used alone or two or more of them may be used in combination. Among them, glass fibers are preferable.

Examples of commercially available products of glass fibers include: chopped glass fiber (ECS03T-790DE, average fiber diameter: 6 µm) manufactured by Nippon Electric Glass Co., Ltd.; chopped glass fiber (CS03DE 416A, average fiber diameter: 6 µm) manufactured by OWENS CORNING JAPAN LLC.; chopped glass fiber (ECS03T-747H, average fiber diameter: 10.5 µm) manufactured by Nippon Electric Glass Co., Ltd.; chopped glass fiber (ECS03T-747, average fiber diameter: 13 µm) manufactured by Nippon Electric Glass Co., Ltd.; modified section chopped strands CSG 3PA-830 (major diameter 28 um, minor diameter 7 µm) manufactured by NITTO BOSEKI CO., LTD.; modified section chopped strands CSG 3PL-962 (major diameter 20 µm, minor diameter 10 µm) manufactured by NITTO BOSEKI CO., LTD., and the like.

The fibrous inorganic filler may be surface-treated by using various surface-treatment agents such as generally known epoxy-based compounds, isocyanate-based compounds, silane-based compounds, titanate-based compounds, and fatty acids. By performing a surface-treatment, the adhesion to the PAS resin can be enhanced. The surface-treatment agent may be applied to the fibrous inorganic filler prior to material preparation to perform a surface or convergence treatment, or may be added simultaneously during material preparation.

The fiber diameter of the fibrous inorganic filler is not particularly limited, but can be 5 µm or more and 30 µm or less in the initial shape (shape before melt-kneading), for example. The fiber diameter of the fibrous inorganic filler refers to the major diameter of the fiber cross section of the fibrous inorganic filler.

Examples of the granular inorganic filler include talc (granular), carbon black, silica, quartz powders, glass beads, and glass powders; silicates such as calcium silicate, aluminum silicate, and diatomaceous earth; metal oxides such as iron oxide, titanium oxide, zinc oxide, and alumina (granular); metal carbonates such as calcium carbonate and magnesium carbonate; metal sulfates such as calcium sulfate and barium sulfate; other silicon carbides; nitrides such as silicon nitride, boron nitride, and aluminum nitride; particles of an insoluble ionic crystal such as calcium fluoride and barium fluoride; fillers using semiconductor materials (element semiconductors such as Si, Ge, Se, and Te; compound semiconductors such as oxide semiconductors); and various metal powders. One of the above may be used alone or two or more of them may be used in combination. Among them, glass beads and calcium carbonate are preferable.

Examples of commercially available products of calcium carbonate include WHITEN P-30 (average particle size (50% d): 5 µm) manufactured by Toyo Fine Chemical Kaisha, Ltd. Further, examples of commercially available products of glass beads include EGB731A (average particle size (50% d): 20 µm) manufactured by Potters-Ballotini Co., Ltd., EMB-10 (average particle size (50% d): 5 µm) manufactured by Potters-Ballotini Co., Ltd., and the like.

The granular inorganic filler may also be surface-treated in the same way as the fibrous inorganic filler.

Examples of the plate-like inorganic filler include glass flakes, talc (plate-like), mica, kaolin, clay, alumina (plate-like), various metal foils, and the like. One or more of them can be used. Among them, glass flakes and talc are preferable.

Examples of commercially available products of glass flakes include REFG-108 (average particle size (50% d): 623 µm) manufactured by Nippon Sheet Glass Co., Ltd., Fineflake (average particle size (50% d): 169 µm) manufactured by Nippon Sheet Glass Co., Ltd., REFG-301 (average particle size (50% d): 155 µm) manufactured by Nippon Sheet Glass Co., Ltd., REFG-401 (average particle size (50% d): 310 µm) manufactured by Nippon Sheet Glass Co., Ltd., and the like.

Examples of commercially available products of talc include crown talc PP manufactured by Matsumura Sangyo Co., Ltd., Talcan Pawder PKNN manufactured by HAYASHI-KASEI CO., LTD., and the like.

The plate-like inorganic filler may also be surface-treated in the same way as the fibrous inorganic filler.

In the present embodiment, among the above inorganic fillers, it is preferable to use one or more kinds selected from the group consisting of glass fibers, glass beads, glass flakes, calcium carbonate, and talc. Further, from the viewpoint of enhancing mechanical properties, it is preferable to add, to 100 parts by mass of the PAS resin, preferably 5 to 250 parts by mass of the inorganic filler, more preferably 15 to 200 parts by mass of the inorganic filler, still more preferably 25 to 150 parts by mass of the inorganic filler, and particularly preferably 30 to 110 parts by mass of the inorganic filler.

### Other Components

In the present embodiment, in order to impart desired properties according to the purpose to the extent that the effect is not impaired, in addition to the above components, the following known additives generally added to thermoplastic and thermosetting resins may be blended: an elastomer, a mold release agent, a lubricant, a plasticizer, a flame retardant, a coloring agent such as a dye or a pigment, a crystallization accelerator, a crystal nucleating agent, various antioxidants, a thermal stabilizer, a weather-resistant stabilizer, a corrosion inhibitor, and the like. Although the occurrence of burrs can be sufficiently suppressed by means of the burr suppression method of the present embodiment, a burr inhibitor such as an alkoxysilane compound may be used in combination when necessary.

There are no particular limitations as for the method of fabricating a molded article using the PAS resin composition according to the present embodiment, and a known method can be adopted. The PAS resin composition according to the present embodiment is put into an extruder, and then melt-kneaded and pelletized to form a pellet, then the pellets are put into an injection-molding machine having a predetermined mold, and accordingly the molded article can be fabricated by means of injection-molding, for example.

Examples of a molded article obtained by molding the PAS resin composition according to the present embodiment include electrical and electronic equipment part materials, automotive equipment part materials, chemical equipment part materials, water service-related part materials, and the like.

Specifically, examples of usage applications of the PAS resin composition include various automobile cooling system parts, ignition related parts, distributor parts, various sensor parts, various actuator parts, throttle parts, power module parts, ECU parts, various connector parts, pipe fittings (pipe joints), joints, and the like.

Other examples of the usage application of the composition include electric and electronic components such as LEDs, sensors, sockets, terminal blocks, printed circuit boards, motor components, and ECU cases; and home and office electric product components such as lighting components, television components, rice cooker components, microwave oven components, iron components, copier related components, printer related components, facsimile related components, heaters, and air conditioner components.

### EXAMPLES

The present embodiment will be described more specifically below by using examples, but the present embodiment is not limited to the following examples.

### Examples 1 to 13 and Comparative Examples 1 to 11

In each example and comparative example, each raw material component shown in Tables 1 and 2 was dry-blended, then put into a twin-screw extruder with a cylinder temperature of 320° C. (glass fibers were added separately from a side-feeding section of an extruder), and thereafter melt-kneaded and pelletized. In Tables 1 and 2, numerical values for each component indicate parts by mass.

Details of each raw material component used are shown below.

### PAS Resin

PPS resin 1: manufactured by KUREHA CORPORATION, Fortron KPS (melt viscosity: 130 Pa·s (shear rate of 1200 sec⁻¹, 310° C.))
PPS resin 2: manufactured by KUREHA CORPORATION, Fortron KPS (melt viscosity: 30 Pa·s (shear rate of 1200 sec⁻¹, 310° C.))

### Measurement of Melt Viscosity of PPS Resin

The melt viscosity of the above PPS resin was measured as follows. The melt viscosity was measured at a barrel temperature of 310° C. and a shear rate of 1200 sec⁻¹ using a flat die of 1 mmφ × 20 mmL as a capillary and a capirograph manufactured by Toyo Seiki Seisaku-sho, Ltd.

### Carbon Material

Carbon nanostructure (CNS): manufactured by Cabot Corporation, ATHLOS 200
Carbon nanotube (CNT): RMB 7015-01 (15 mass% of the PPS resin, masterbatch, manufactured by Hyperion Catalysis International, average diameter of carbon nanotube, 10 nm, aspect 100 to 1000, nitrogen content per kg, 0.82 g)
Carbon black: manufactured by Mitsubishi Chemical Corporation, Mitsubishi Carbon Black #750B, primary particle size: 22 µm/pH 7.5/DBP absorption: 116 cm³/100 g

### Inorganic Filler

Glass fiber: manufactured by OWENS CORNING JAPAN LLC., chopped strands, fiber diameter: 10.5 pm, length: 3 mm

TABLE 1

| | | Example 1 | Example 2 | Example 3 | Example 4 | Example 5 | Example 6 | Example 7 | Example 8 | Example 9 | Example 10 | Example 11 | Example 12 | Example 13 |
|---|---|---|---|---|---|---|---|---|---|---|---|---|---|---|
| PAS resin | PPS resin 1 | 100 | 100 | 100 | 100 | - | - | - | - | - | - | - | - | - |
| | PPS resin 2 | - | - | - | - | 100 | 100 | 100 | 100 | 100 | 100 | 100 | 100 | 100 |
| Carbon material | CNS | 0.08 | 0.17 | 0.84 | 5.0 | 0.08 | 0.17 | 0.30 | 0.50 | 0.84 | 1.7 | 2.5 | 3.0 | 5.0 |
| Inorganic filler | Glass fiber | 67 | 67 | 67 | 70 | 67 | 67 | 67 | 67 | 67 | 68 | 69 | 69 | 70 |
| Burr length (µm) | | 142 | 103 | 39 | <30 | 199 | 139 | 72 | 47 | 34 | <30 | <30 | <30 | <30 |
| Melt viscosity (Pa · s) | | 334 | 334 | 372 | 589 | 145 | 146 | 154 | 164 | 173 | 189 | 222 | 250 | 342 |

TABLE 2

| | | Comparative Example 1 | Comparative Example 2 | Comparative Example 3 | Comparative Example 4 | Comparative Example 5 | Comparative Example 6 | Comparative Example 7 | Comparative Example 8 | Comparative Example 9 | Comparative Example 10 | Comparative Example 11 |
|---|---|---|---|---|---|---|---|---|---|---|---|---|
| PAS resin | PPS resin 1 | 100 | - | 100 | 100 | - | - | 100 | 100 | - | - | 100 |
| | PPS resin 2 | - | 100 | - | - | 100 | 100 | - | - | 100 | 100 | - |
| Carbon material | CNT | - | - | 0.17 | 0.84 | 0.17 | 0.84 | - | - | - | - | - |
| | Carbon black | - | - | - | - | - | - | 0.17 | 0.84 | 0.17 | 0.84 | - |
| | CNS | - | - | - | - | - | - | - | - | - | - | 5.4 |
| Inorganic filler | Glass fiber | 67 | 67 | 67 | 67 | 67 | 67 | 67 | 67 | 67 | 67 | 70 |
| Burr length (µm) | | 275 | 461 | 155 | 55 | 197 | 68 | 242 | 151 | 370 | 293 | <30 |
| Melt viscosity (Pa · s) | | 334 | 125 | 335 | 370 | 130 | 150 | 332 | 389 | 130 | 129 | 620 |

### Evaluation

The following evaluation was performed using the obtained pellets of each example and each comparative example.

### Burr Length

A disk-shaped cavity mold was used in which a burr measuring part having a 20 µm mold gap in a part is disposed on the outer periphery. By using the mold, injection-molding was performed at a cylinder temperature of 320° C. and a mold temperature of 150° C. at the minimum pressure required for completely filling the cavity. Then, the length of a burr that occurred in the area was enlarged by using a mapping projector and measured. The measurement results are shown in Tables 1 and 2.

### Melt Viscosity of Resin Composition

The melt viscosity (MV) was measured at a barrel temperature of 310° C. and a shear rate of 1000 sec⁻¹ by using a flat die of 1 mmφ × 20 mmL as a capillary and a capirograph manufactured by Toyo Seiki Seisaku-sho, Ltd. The measurement results are shown in Tables 1 and 2. If the melt viscosity is 600 Pa · s or less, it can be said that the fluidity is excellent.

Tables 1 and 2 reveal the following.

In all of Examples 1 to 4, different amounts of a CNS were added using PPS resin 1. It can be observed that the burr length becomes shorter as the addition amount of the CNS is increased. Similarly, in all of Examples 5 to 13, different amounts of the CNS were added using PPS resin 2. It can be observed that the burr length becomes shorter as the addition amount of the CNS is increased.

It can also be observed that all of the examples have sufficient fluidity.

In all of Example 2, Comparative Example 3, and Comparative Example 7, PPS resin 1 was used, the addition amount of the carbon material was the same (0.17 parts by mass), and the types of the carbon material were different. Example 2 had the shortest burr length. Similarly, in all of Example 3, Comparative Example 4, and Comparative Example 8, PPS resin 1 was used, the addition amount of the carbon material was the same (0.84 parts by mass), and the types of the carbon material were different. Example 3 had the shortest burr length. In addition, in all of Example 6, Comparative Example 5, and Comparative Example 9, PPS resin 2 was used, the addition amount of the carbon material was the same (0.17 parts by mass), and the types of the carbon material were different. Example 6 has the shortest burr length. Similarly, in all of Example 9, Comparative Example 6, and Comparative Example 10, PPS resin 2 was used, the addition amount of the carbon material was the same (0.84 parts by mass), and the types of the carbon material were different. Example 9 had the shortest burr length. From the above comparison, it can be observed that the occurrence of burrs is notably suppressed by the addition of the CNS.

Meanwhile, in Comparative Example 11, in which the addition amount of the CNS was more than 5 parts by mass (5.4 parts by mass), although the suppression of the occurrence of burrs was sufficient, the melt viscosity was increased notably.

From the above, it is possible to suppress the occurrence of burrs significantly by adding a CNS compared to when other carbon materials are used.

1. A method of suppressing burrs that occur during injection-molding of a polyarylene sulfide resin composition, comprising:
adding at least a carbon nanostructure to a polyarylene sulfide resin and melt-kneading at least the carbon nanostructure and the polyarylene sulfide resin, wherein
the content of the carbon nanostructure is 0.01 to 5 parts by mass with respect to 100 parts by mass of the polyarylene sulfide resin.

2. The method of suppressing burrs of the polyarylene sulfide resin composition according to claim 1, further comprising:
adding 5 to 250 parts by mass of an inorganic filler to 100 parts by mass of the polyarylene sulfide resin and melt-kneading at least the inorganic filler and the polyarylene sulfide resin.

3. The method of suppressing burrs of the polyarylene sulfide resin composition according to claim 2, wherein
the inorganic filler is one or more selected from the group consisting of glass fibers, glass beads, glass flakes, calcium carbonate, and talc.
